(19) United States
(12) Patent Application Publication
(10) Pub. No.: US 2017/0003571 A1
(43) Pub. Date: Jan. 5, 2017

(54) INTEGRATED OPTICAL MODULATOR OF THE MACH-ZEHNDER TYPE

(71) Applicants: STMicroelectronics (Crolles 2) SAS, Crolles (FR); STMicroelectronics SA, Montrouge (FR)

(72) Inventors: Jean-Francois Carpentier, Grenoble (FR); Patrick LeMaitre, Biviers (FR); Denis Pache, Grenoble (FR)

(73) Assignees: STMicroelectronics (Crolles 2) SAS, Crolles (FR); STMicroelectronics SA, Montrouge (FR)

(21) Appl. No.: 15/068,704

(22) Filed: Mar. 14, 2016

(30) Foreign Application Priority Data
Jul. 2, 2015 (FR) 1556214

(51) Int. Cl. G02F 1/225; G02F 1/025; G02F 1/01

(52) U.S. Cl. CPC G02F 1/2255; G02F 1/0123; G02F 1/025; G02F 1/2257; G02F 2001/212

(57) ABSTRACT

An integrated modulator of the Mach-Zehnder type includes two optical arms containing waveguides with PN junctions and biasing circuits for reverse biasing the PN junctions in response to a control signal. The two optical arms are situated within a semiconductor substrate of a first element that also has an interconnection region. The biasing circuits are situated, in part, within a substrate of a second element that also contains an interconnection region. The first and second elements are rigidly attached to each other via their respective interconnection regions.

### PRIORITY CLAIM

This application claims priority from French Application for Patent No. 1556214 filed Jul. 2, 2015, the disclosure of which is incorporated by reference.

### TECHNICAL FIELD

Various embodiments of the invention relate to integrated circuits and, more particularly, the modulation of optical signals by modulators of the Mach-Zehnder type, for example in which the optical waveguides are partially curved.

### BACKGROUND

In general, a modulator of the Mach-Zehnder type comprises an optical waveguide which is locally divided into two identical arms. A control signal is applied to at least one of the two arms in order to bias a PN junction so as to create a phase difference between the optical signals of each of the two arms. Depending on the total phase difference, the light will recombine more or less at the exit of the modulator leading to a modulation of the light power.

When the control signal is representative of digital data to be transmitted, at the exit of the modulator, an optical signal modulated according to the data is obtained which can be transmitted over a very long optical fiber.

Currently, optical modulators of the Mach-Zehnder type are known in integrated circuits, incorporating waveguides and means for biasing junctions. However, the existing modulators suffer from problems of propagation of the modulating control signal when using high frequency signals which are rapidly attenuated.

### SUMMARY

According to one embodiment, a novel, particularly compact, modulator structure of the Mach-Zehnder type is provided limiting the risk of attenuation of a high-frequency modulating control signal.

According to one embodiment, an optical modulator of the Mac-Zehnder type is provided, in which the arms of the modulator can take the form of a serpentine and can be active over the whole of their length.

According to one aspect, an integrated modulator of the Mach-Zehnder type is provided comprising two optical arms containing waveguides with PN junctions and biasing means for biasing the junctions, for example reverse biasing, in response to a control signal.

According to one general feature of this aspect, the two optical arms are situated within a semiconductor substrate of a first element also having an interconnection region, commonly denoted by those skilled in the art under the acronym BEOL (Back End Of Line), covering the substrate, and the biasing means are situated, in part, within a substrate of a second element also containing an interconnection region and, in part, within the interconnection regions of the two elements rigidly attached to each other via their respective interconnection region.

In other words, according to this aspect, the present invention differs from the prior art, in which the Mach-Zehnder modulators are two-dimensional, in other words situated entirely within an integrated circuit, by the fact that a three-dimensional Mach-Zehnder modulator is provided whose waveguides with PN junctions, active over their whole length, are situated within a first element, for example a substrate of the SOI type, and the biasing means are situated, in part, within the substrate of a second element of a three-dimensional structure, allowing a particularly compact integrated device to be obtained, thus avoiding too long a propagation of the high-frequency modulating control signal.

Each interconnection region comprises metal bonding pads rigidly fixed together in such a manner as to form electrically-conducting pillars, and the biasing means comprise
control components situated within the substrate of the second element,
first electrically-conducting links situated within the interconnection region of the first element and coupled to the waveguides with PN junctions,
pillars coupled to the first links and
second electrically-conducting links situated within the interconnection region of the second element and coupled between the pillars and the control components.

The optical arms may be divided into a succession of separate optically-coupled and mutually electrically-isolated cells and the biasing means may be divided into a succession of control blocks respectively associated with the cells and situated directly in line with the cells.

An efficient biasing of the corresponding junctions is thus obtained without risk of attenuation of a high-frequency modulating control signal

The control blocks are configured for receiving the control signal and sequentially biasing the corresponding cells taking into account their rank within the succession.

Each cell furthermore advantageously comprises two parallel portions of optical arms each having a continuous PN junction.

In one embodiment, each continuous PN junction comprises a rectilinear portion and a curved portion, the succession of the cells forming two parallel arms in the shape of a serpentine.

Preferably, the control signal is a radiofrequency signal and the length of each continuous PN junction of each cell is less than the wavelength of the radiofrequency control signal.

According to another aspect, a three-dimensional structure is provided incorporating the integrated modulator of the Mach-Zehnder type defined hereinbefore.

Other advantages and features of the invention will become apparent upon examining the detailed description of non-limiting embodiments and their implementation and from the appended drawings in which:

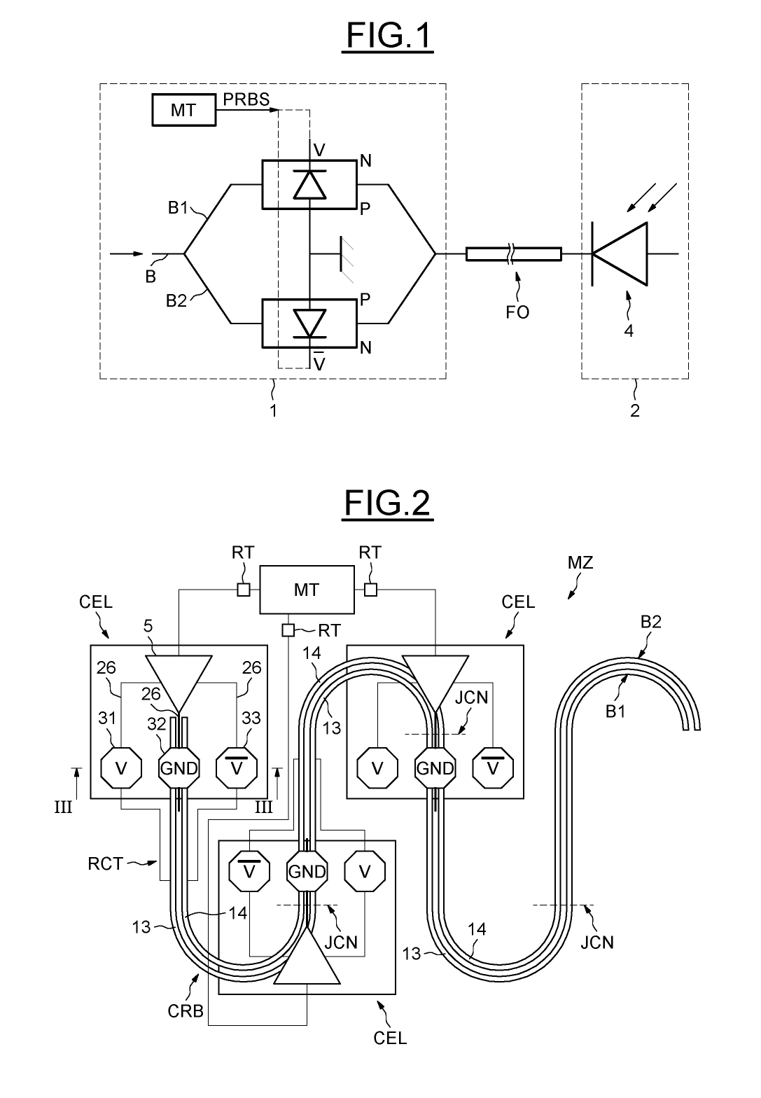

FIG. 1 shows schematically a transmitter-receiver system comprising a modulator of the Mach-Zehnder type, and

FIGS. 2 to 5 illustrate schematically various embodiments.

### DETAILED DESCRIPTION

In FIG. 1, the reference 1 denotes a transmission system comprising a Mach-Zehnder modulator MZ.

It is composed of a main waveguide B, dividing at one point into two separate waveguides forming the arms B1 and B2 of the modulator.

When a light signal SIG enters via the first end of the modulator, it is divided into two identical signals each going via one of the two arms B1 and B2.

In this example, the arms of the modulator comprise continuous PN junctions, for which the junction P is connected to ground, and the N junctions are connected to a first potential V for the first arm 11, and to a second potential V̅ for the second arm 12, in such a manner as to reverse bias the junctions.

A processing means MT, comprising for example a processor and a serializer, delivers a signal PRBS for biasing the junctions of one or the other of the two arms B1 and B2 in order to modulate the optical signal propagating in them.

This signal PRBS is representative of the digital data to be optically transmitted. Thus, depending on the logical value of the data, the signal PRBS takes a high state (V) or a low state (V̅).

The two optical signals subsequently recombine into a single optical signal modulated in amplitude which is transmitted to a receiving system 2 via an optical interface FO, for example an optical fiber.

The receiving means 2 can notably comprise a photodiode 4 which converts the optical signal into an electrical signal in order to extract from it the digital data.

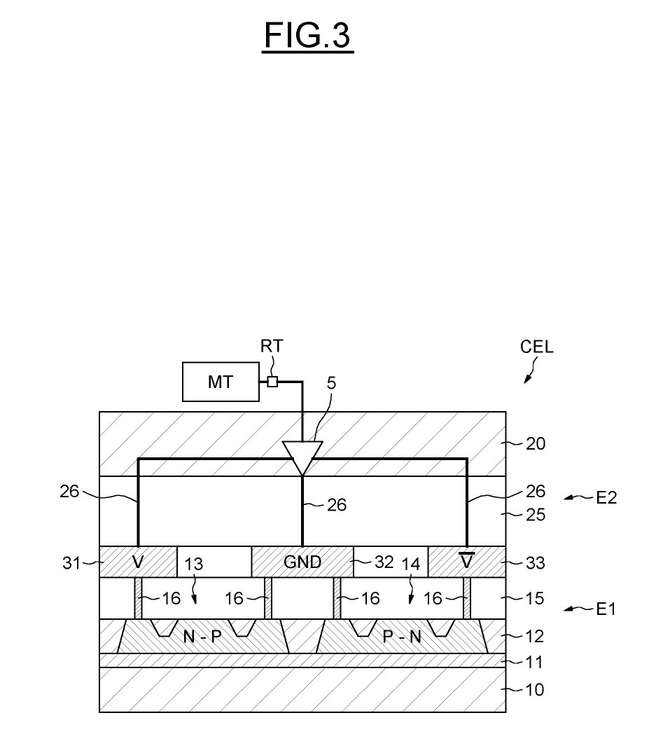

A Mach-Zehnder modulator according to one embodiment is now described in more detail hereinafter, referring more particularly to FIG. 2 and to FIG. 3 which is a cross-sectional view of FIG. 2 through the cross section III-III.

It can be seen in these figures that the Mach-Zehnder modulator MZ is incorporated within a three-dimensional integrated structure. The waveguides B1 and B2 are included within a first element E1, whereas the biasing means are, in part, within a second element E2, rigidly attached to the first element E1.

The first element E1 here is, for example, a substrate of the SOI type and the second element E2 a second substrate of the SOI type or otherwise. Either one of the elements E1 and E2 may also be, for example, an interposer.

The first element E1 comprises, on top of a carrier substrate 10, an insulating layer of oxide 11, known by those skilled in the art using the term “buried oxide” (BOX), over which a semiconductor film 12 is placed, for example made of silicon. An interconnection region 15, commonly denoted by those skilled in the art under the acronym BEOL (Back End Of Line), covers this semiconductor film 12.

The second element comprises a substrate 20 supporting a BEOL interconnection layer 25.

The two elements E1 and E2 comprise, on their respective BEOL layer, bonding pads which are used to render rigid the integrated structure by a metal-metal bonding, an insulator-insulator bonding being obtained between the bonding pads. The bonding pads form, after bonding, conducting pillars 31, 32, 33.

The waveguides B1 and B2 are divided into several analogous cells CEL.

Each of the cells comprises two PN junctions 13 and 14, which are portions of the waveguides B1 and B2, situated within the semiconductor film 12 of the first element E1,

Each of the PN junctions 13 and 14 is continuous and comprises a rectilinear part RCT and a curved part CRB. Thus, the waveguides B1 and B2, which are the juxtaposition of the PN junctions 13 and 14 of each cell, form serpentines.

The cells CEL are mutually electrically isolated, notably at the spacing JCN between each PN junction. This gap JCN isolates the cells electrically, but not optically. The PN junctions 13 and 14 of each cell are therefore optically coupled together.

The means for biasing the junctions will now be described in more detail.

The biasing means comprise the processing means MT, which delivers the signal PRBS, and various control blocks 5 associated with the various cells CEL and situated within the substrate of the second element directly in line with the cells. These control blocks (“drivers”) may comprise one or more inverters.

The length of the continuous PN junctions 13 and 14 is chosen so as to be shorter than the wavelength of the high-frequency modulating signal PRBS. This also avoids having too high an equivalent capacitance seen by the control block 5.

Each control block 5 is connected to the processing means MT via a delay means RT, for example a delay line. Thus, it receives the information with a delay preventing the control block from biasing its associated PN junction before the optical signal arrives at its cell.

The biasing means also comprise
electrical links 26 situated within the BEOL part of the second element E2,
the contact pillars 31, 32, 33, and
other electrical links 16 situated within the BEOL part of the first element E3.

More precisely, the links 26 are coupled to the corresponding control block 5 and each come into contact with one of the pillars 31, 32, and 33, and the links 16 each come into contact with one of the contact pillars 31, 32, 33 and are connected to the PN junctions.

The links 16 and 26 comprise, for example, stacks of vias and portions of metal tracks.

The PN junctions 13 and 14 are reverse biased. The control block transmits for example the signal V over the first contact pillar 31, and a signal V̅ over the third contact pillar 31. The ground GND is connected to the parts P of the junctions 13 and 14 by the pillar 32.

The processing means MT can be advantageously situated within the substrate of the second element in the middle of the control blocks 5 in such a manner as to limit, as far as possible, the propagation of the signal PRBS.

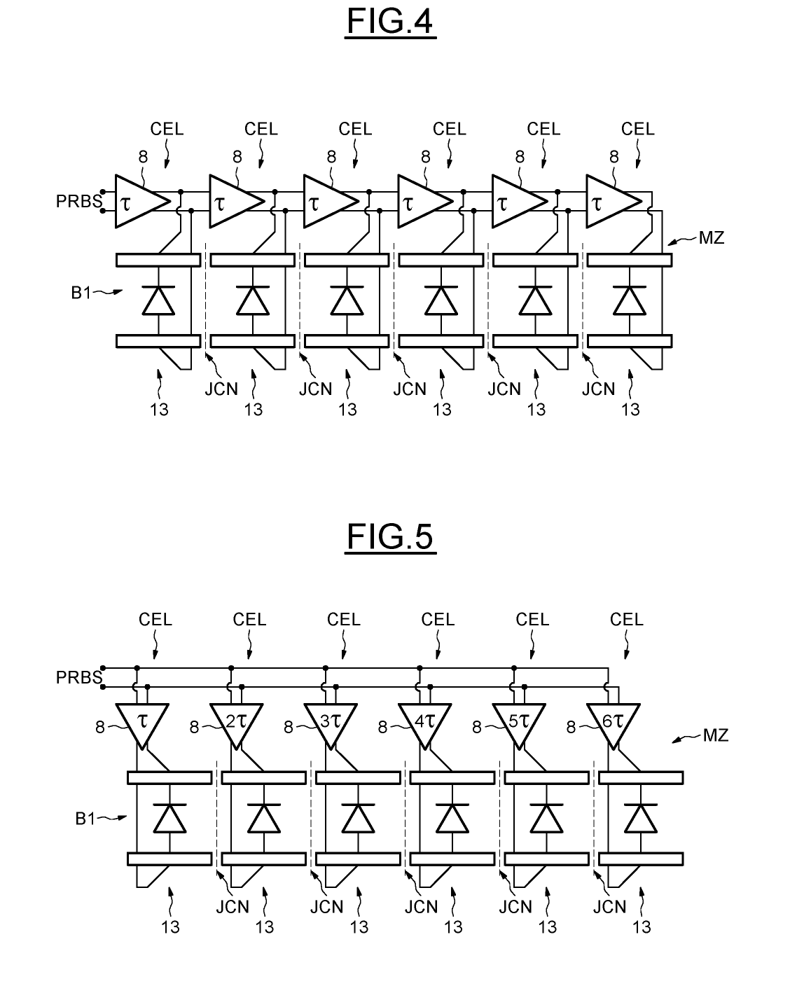

FIGS. 4 and 5 illustrate schematically two embodiments relating to the arrangement of the control blocks 5 and of the delay means RT. For the sake of simplification, only one optical arm B1 is shown, and each control means 5 associated with a delay means RT is represented by a block 8.

In the embodiment illustrated in FIG. 4, the various blocks 8 are connected in series.

Thus, each block 8 biases its associated PN junction 13 with an identical delay τ irrespective of its position on the waveguide B1, but since the blocks 8 are connected in series, they receive the electrical signal after the application of the delay of the preceding block. Thus, each cell CEL will be biased with a delay equal to the sum of the delays of the preceding blocks 8.

In the embodiment illustrated in FIG. 5, the various blocks 8 are connected in parallel.

Thus, each block 8 simultaneously receives the modulating signal, but biases the PN junction 13 of its cell CEL with a different delay, which is a function of its position on the waveguide B1. Thus, the further the cell is situated along the optical arm, the longer will be the delay applied by the block 8 (For example, the first cell will apply a delay τ, the second cell a delay 2τ, etc.).

It should be noted that the embodiments shown here are in no way limiting. Notably, although in this example the PN junctions 13 and 14 are reverse biased, a configuration in which one or the other of the junctions 13 and 14 would be forward biased with a voltage lower than the threshold voltage (in a low-injection mode of operation) is perfectly possible.

1. An integrated modulator of the Mach-Zehnder type, comprising:
two optical arms containing waveguides with PN junctions; and
a biasing circuit configured to bias the PN junctions in response to a control signal;
wherein the two optical arms are situated within a semiconductor substrate of a first element having an interconnection region covering the semiconductor substrate;
wherein the biasing circuit is situated, in part, within a substrate of a second element also having an interconnection region; and
circuit connections situated within the interconnection regions of the two elements;
wherein the two elements are rigidly attached together through their respective interconnection regions.

2. The modulator according to claim 1, wherein the circuit connections comprise: the interconnection regions including metal bonding pads rigidly attached together in such a manner as to form electrically-conducting pillars.

3. The modulator according to claim 2, wherein the biasing circuit comprises control circuit components situated within the substrate of the second element.

4. The modulator according to claim 3, wherein the circuit connections comprise first electrically-conducting links situated within the interconnection region of the first element and coupled to the waveguides with PN junctions, pillars coupled to the first electrically-conducting links and second electrically-conducting links situated within the interconnection region of the second element and coupled between the pillars and the control circuit components.

5. The modulator according to claim 1, wherein the optical arms are divided into a succession of separate cells that are optically coupled and mutually electrically isolated, and wherein the biasing circuit is divided into a succession of control blocks respectively associated with the cells, and wherein the control blocks are configured to receive a control signal and sequentially bias the corresponding cells taking into account their rank within the succession.

6. The modulator according to claim 5, wherein the control blocks are situated directly in line with the cells.

7. The modulator according to claim 5, wherein each cell comprises two parallel portions of optical arms each having a continuous PN junction.

8. The modulator according to claim 7, wherein each continuous PN junction comprises a rectilinear portion and a curved portion, the succession of the cells forming two parallel arms in the shape of a serpentine.

9. The modulator according to either of claim 5, wherein the control signal is a radiofrequency signal and the length of each continuous PN junction of each cell is shorter than a wavelength of the radiofrequency control signal.

10. The modulator according to claim 1, implemented in an integrated three dimensional structure formed by said first and second elements.

11. An optical modulator, comprising:
an optical waveguide having an input and an output, said optical waveguide comprising a first straight section that is connected in series with a first curved section; and
a first PN junction phase shifter having a first straight portion extending along the first straight section and a first curved portion extending along the first curved section.

12. The optical modulator of claim 11, further comprising a driver circuit comprising a first driver having inputs and having outputs coupled to drive operation of the first PN junction phase shifter.

13. The optical modulator of claim 12,
wherein the optical waveguide and the first PN junction phase shifter are fabricated on a first substrate;
wherein the driver circuit is fabricated on a second substrate; and
wherein the second substrate is stacked over the first substrate.

14. The optical modulator of claim 11,
wherein the optical waveguide further comprises a second straight section that is connected in series with a second curved section, wherein the first and second straight sections are parallel and the first and second curved sections are parallel; further comprising:
a second PN junction phase shifter having a second straight portion extending along the second straight section and a second curved portion extending along the second curved section.

15. The optical modulator of claim 14, further comprising a driver circuit comprising a first driver having inputs and having outputs coupled to drive operation of the first and second PN junction phase shifters with opposite phase drive signals.

16. The optical modulator of claim 15,
wherein the optical waveguide and the first and second PN junction phase shifters are fabricated on a first substrate;
wherein the driver circuit is fabricated on a second substrate; and
wherein the second substrate is stacked over the first substrate.

17. The optical modulator of claim 11,
wherein the optical waveguide further comprises a second straight section that is connected in series with a second curved section, wherein the second straight section is connected in series with the first curved section; further comprising:
a second PN junction phase shifter having a second straight portion extending along the second straight section and a second curved portion extending along the second curved section.

18. The optical modulator of claim 17, further comprising a driver circuit comprising:
a first driver having inputs and having outputs coupled to drive operation of the first PN junction phase shifter; and
a second driver having inputs and having outputs coupled to drive operation of the second PN junction phase shifter.

19. The optical modulator of claim 18,
wherein the optical waveguide and the first and second PN junction phase shifters are fabricated on a first substrate;
wherein the driver circuit is fabricated on a second substrate; and
wherein the second substrate is stacked over the first substrate.

20. An optical modulator, comprising:
an optical waveguide having an input and an output, said optical waveguide comprising a first straight section that is connected in series with a first curved section that is connected in series with a second straight section that is connected in series with a second curved section;
a first PN junction phase shifter having a straight PN junction portion extending along the first straight section and a curved PN junction portion extending along the first curved section; and
a second PN junction phase shifter having a straight PN junction portion extending along the second straight section and a curved PN junction portion extending along the second curved section.

21. An optical modulator, comprising:
an optical waveguide having a first waveguide arm and a second waveguide arm, said first and second waveguide arms being parallel to each other, said first waveguide arm comprising a first straight section that is connected in series with a first curved section, said second waveguide arm comprising a second straight section that is connected in series with a second curved section;
a first PN junction phase shifter having a straight PN junction portion extending along the first straight section and a curved PN junction portion extending along the first curved section; and
a second PN junction phase shifter having a straight PN junction portion extending along the second straight section and a curved PN junction portion extending along the second curved section.
